(19) United States
(12) Patent Application Publication
(10) Pub. No.: US 2021/0266192 A1
(43) Pub. Date: Aug. 26, 2021

(54) METHOD OF CONFIGURING A CENTRAL CONTROL UNIT BELONGING TO A HOME AUTOMATION SYSTEM

(71) Applicant: OVERKIZ, METZ-TESSI (FR)

(72) Inventor: Sylvain POGNANT, SEYNOD (FR)

(21) Appl. No.: 17/254,063

(22) PCT Filed: Jun. 17, 2019
(86) PCT No.: PCT/FR2019/051466

§ 371 Date: Dec. 18, 2020

(30) Foreign Application Priority Data
Jun. 20, 2018 (FR) 1855414

(51) Int. Cl. H04L 12/28; H04L 12/24

(52) U.S. Cl. CPC H04L 12/2814; H04L 41/082; H04L 41/0806

(57) ABSTRACT

A method for configuring a communication terminal for the command of a central control unit or of a home-automation device belonging to a home-automation installation, the method being implemented by the communication terminal, an initial configuration of the communication terminal comprising at least one container application, the method, implemented by the communication terminal, comprising the following steps: —reception of an interface application and/or of parametrization data of the the interface application, which are downloaded from the central control unit or from an external storage unit; —adaptation of the configuration of the communication terminal, the adaptation step comprising installation of the interface application downloaded on the communication terminal and/or a parametrization of an interface application, present on the communication terminal before the reception step, so as to render the interface application compatible with a predetermined version of functional software of the central control unit.

### CROSS REFERENCE TO RELATED APPLICATIONS

This application is a National Stage of PCT Application No. PCT/FR2019/051466 filed on Jun. 17, 2019, which claims priority to French Patent Application No. 18/55414 filed on Jun. 20, 2018, the contents each of which are incorporated herein by reference thereto.

### FIELD OF THE INVENTION

The present invention concerns a method for configuring a communication terminal for monitoring a central control unit or a home automation device belonging to a home automation installation.

### BACKGROUND

A home automation installation of a building can comprise one or several home automation device(s). It is known to proceed with the monitoring, that is to say with the control and/or the supervision of said installation by using a central control unit which communicates with one or several home automation device(s). Such a central control unit can be, integrated into a home automation device or independent.

A central control unit must be configured to allow its interaction with the home automation device(s) or remote functional services, such as for example a user service.

A large number of different configurations can be envisaged for the same central control unit, which implies implementing a configuration method adapted in particular as a function of the devices or services to be connected, or of carrying out an in situ configuration when placing the central control unit in the home automation installation, this configuration can prove to be complex.

The monitoring of the central unit or the home automation installation can be carried out via a communication terminal. Nonetheless, the configuration of the communication terminal must be adapted to the version of the operating system or the functional software of the central control unit, in order to allow a communication between the communication terminal and the central control unit. Yet, the version of said operating system or functional software of the central unit is unknown to the communication terminal. Likewise, the configuration of the communication terminal is liable to change, for example, to improve its functions or to make various functional corrections. It is therefore necessary to configure the communication terminal in order to adapt its configuration to the version of the operating system installed in the central control unit.

The object of the present invention is to resolve all or part of the problems mentioned above.

### BRIEF SUMMARY

To this end, the present invention concerns a method for configuring a communication terminal for controlling a central control unit or a home automation device belonging to a home automation installation, the method being implemented by the communication terminal, an initial configuration of the communication terminal comprising at least one container application, the method, implemented by the communication terminal, comprising the following steps:
receiving an interface application and/or setting data from said interface application, downloaded from the central control unit or from an outer storage unit;
adapting the configuration of the communication terminal, the adaptation step comprising an installation of the interface application downloaded on the communication terminal and/or setting an interface application, present on the communication terminal before the reception step, in order to make the interface application compatible with a predetermined version of a functional software of the central control unit.

Thanks to these arrangements, if the version of the functional software and/or the setting of the interface application of the central control unit change independently of the configuration of the communication terminal, the configuration of the communication terminal can always be updated to be compatible with the current version.

According to an implementation mode, the invention comprises one or several of the following characteristics, alone or in combination.

According to an implementation mode, the method further comprises the following step:
transmitting a request to download the interface application;

According to an implementation mode, the method further comprises the following steps:
transmitting a discovery message;
receiving an identification message containing the download address of an interface application;

According to an implementation mode:
the step of transmitting the discovery message, and
the step of receiving the identification message,
are performed according to a first communication protocol, and the step of receiving the interface application is performed according to a second communication protocol.

Thanks to these arrangements, the first communication protocol can be a very simple protocol suitable for discovering the central control unit, that is to say for a communication between the transmitting terminal and electronic units within the electromagnetic range of the transmitter, without a predetermined recipient of the transmitted message. The second communication protocol may be a communication protocol suitable for downloading data and configured to communicate in a point-to-point mode.

According to an implementation mode, the step of transmitting the download request is performed according to a second communication protocol.

According to an implementation mode, the invention also concerns a method for monitoring a central control unit or a home automation device belonging to a home automation installation implemented by a communication terminal, an initial configuration of the communication terminal comprising at least one container application, the central control unit comprising a predetermined version of functional software and at least one communication module arranged to communicate with the container application, the method comprising the following steps:
implementing the configuration method according to any of the preceding claims;
sending a monitoring message to the central control unit via the installed and/or set interface application, during an adaptation step of the configuration method.

Thanks to these arrangements, if the version of the functional software and/or the setting of the interface application of the central control unit change, regardless of the configuration of the communication terminal, the configuration of the communication terminal can always be updated to be made compatible with the current version, and allow the communication terminal to regain the monitoring of the central control unit.

Thanks to these arrangements, the configuration of the communication terminal is adapted to the predetermined version of the functional software and/or the configuration of the interface application of the central control unit before the monitoring of the central control unit and/or at least one home automation device of the home automation installation.

According to an implementation mode, the invention also concerns a method for configuring a communication terminal for monitoring a central control unit or a home automation device belonging to a home automation installation, an initial configuration of the terminal communication unit comprising at least one container application, the method being implemented by the central control unit, the central control unit comprising at least one communication module designed to communicate with the container application, as well as a functional software and an interface application for said functional software, the method, implemented by the central control unit, comprising the following step:
downloading, via the communication module, the interface application and/or setting data of said interface application on the communication terminal.

According to an implementation mode, the configuration method comprises a step of:
receiving, via the communication module, a download request, transmitted by the communication terminal.

According to an implementation mode, the configuration method comprises the following steps:
receiving a discovery message coming from the communication terminal;
transmitting an identification message containing the download address of an interface application, intended for the communication terminal;

According to an implementation mode, the step of receiving the discovery message, and the step of transmitting the identification message, are carried out according to a first communication protocol, and the step of downloading the application interface is implemented according to a second communication protocol.

According to an implementation mode, the step of receiving the download request is performed according to a second communication protocol.

The communication terminal can be a movable communication terminal, for example, a smart phone, a laptop or a tablet. Alternatively, the final user could also make use of a fixed terminal such as a desktop computer.

For the purposes of the present invention, the configuration of a communication terminal is determined by the application(s) which are installed on said terminal and which allow it to communicate, whether locally or via a wide area network, according to one or several communication protocols, with one or several central control units, and/or the setting of the applications installed on said terminal.

The minimum configuration of a communication terminal comprises a discovery software module, also called a container application, which allows the terminal to communicate, at least in a discovery mode and according to a first protocol, with the central unit(s) which are located in the vicinity. This first protocol can be, for example an adhoc WI FI, Bluetooth, or BLE protocol, for direct communication between a central unit and the terminal. The container application is a is a constituent element of the basic configuration of the communication terminal. The adaptations to the configuration of the communication terminal, as implemented by the configuration method, complete the basic configuration by adding new interface applications and/or by modifying the setting of existing interface applications, without modifying the functions of the container application.

For the purposes of the present invention, a home automation device is a home automation equipment and/or a sensor, or even a part of home automation equipment or a sensor part corresponding to a functional sub-assembly. A home automation device can also correspond to a control point for other home automation devices.

For the purposes of the present invention, a home automation installation is an assembly comprising at least one home automation device and at least one central control unit disposed in a single building or in a plurality of places, each home automation device being connected to a central control unit among the plurality of central control units, the plurality of central control units forming a group under the monitoring of a user. The home automation devices form groups of at least one home automation device attached to a central control unit.

For the purposes of the present invention, a central control unit for the home automation installation is an electronic unit comprising:
at least one processing unit designed to contain and execute at least one computer program,
at least one communication module intended to the monitoring and/or the controlling of at least one home automation device;
at least one communication module designed to communicate with the management unit; and/or
at least one communication module arranged to communicate with the discovery software module, or container application of a communication terminal.

The electronic unit can be independent or integrated into a home automation device. In the latter case, the communication module is intended to the monitoring and/or the controlling of the device may be a communication module inner to the home automation device and/or a communication module intended to the monitoring and/or the controlling of other home automation devices. In certain applications, a central control unit can communicate with the management unit through an intermediate management unit, for example from a third-party service provider, whose intermediate management unit offers a service interface or API (for «Application Program Interface»).

It is also possible that the central control unit is integrated into a router and/or a modem making a connection to a wide area network, in particular to the Internet.

For the purposes of the present invention, the functions of a central control unit are ensured by an operating system or functional software that runs on at least one processing unit of the central control unit. In the following, the designation of functional software will be mainly used. The functional software of a central control unit is likely to evolve frequently, to improve its functions or to make various functional corrections. Each evolution of said functional software gives rise to a new version of this software.

By user, it can be understood a final user, an installer or even a maintenance operator.

According to an aspect of the invention, the management unit executing the remote service is a server connected remotely to the at least one home automation installation, via a wide area network. It should be noted that the term server is a logical designation that can cover the use of several physical servers to distribute the IT processing load to be carried out.

According to another aspect of the invention, the management unit(s) executing the first configuration service can be a central unit intended to be connected to one or several central control units on private networks, also called separate local networks, or even on the same local network.

The supervision generally corresponds to a supervision based on the processing of the values of state variables of at least one home automation device or a central control unit.

For the purposes of the present invention, a state variable is a descriptive element of the state of a home automation device. The value of a state variable can correspond to the switch turned on or off, or to a degree or percentage of open for a shutter. Moreover, a state variable may correspond to a measurement value of a sensor, for example to a value of a physical or an environment magnitude. The description of device states can be generic or specialized, depending on the local protocol. The identifiers of state variables can be numeric or alphanumeric. The values of state variables can use custom or proprietary formats or scales.

For the purposes of the present invention, a control corresponds to an order that can be given to a home automation device or to a central control unit with a view to perform an action by a device or to obtain an information in return, for example information relating to a state variable of this device.

For the purposes of the present invention, a message is an element of information notified or received via a communication module from an external device, or in the form of a synchronous or asynchronous call, which may also correspond to a local or distant function call.

The various aspects defined above which are not incompatible can be combined.

### BRIEF DESCRIPTION OF THE FIGURES

The invention will be better understood using of the detailed description which is exposed below with reference to the accompanying drawings in which:

FIG. 1 is a schematic view of a building and a home automation installation according to an embodiment of the invention;

FIG. 2 is a diagram showing an architecture of a system comprising a home automation installation with a central control unit and a communication terminal;

FIG. 3 is a diagram illustrating one embodiment of a configuration method;

FIG. 4 illustrates an example of implementation of the method according to a particular configuration of the used communication terminal.

### DESCRIPTION WITH REFERENCE TO FIGURES

In the following detailed description of the figures defined above, the same elements or the elements fulfilling identical functions may retain the same references so as to simplify the understanding of the invention.

Description of a System Comprising a Home Automation Installation

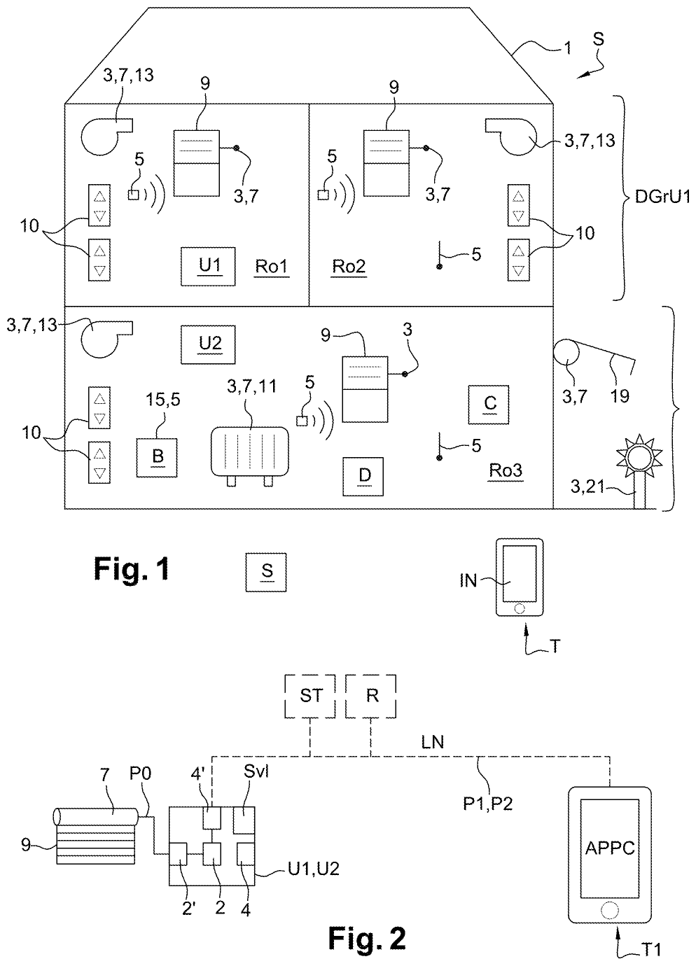

As illustrated in FIG. 1, a building 1 comprises, for example, three rooms Ro1, Ro2, Ro3. The building 1 also comprises home automation equipment 3 and sensors 5.

A home automation equipment 3 can be an actuator arranged to displace or adjust an element of the building 1, for example an actuator 7 to displace a roller shutter 9 or a patio awning 19, or a regulation system 10 for a heating 11 or a ventilation system 13. The home automation equipment 3 can also be lighting, for example exterior lighting for a terrace 21 or a lighting control system, an alarm system, or even a video camera, particularly a video surveillance camera.

The home automation installation Su can also comprise a control point 15 of an actuator 7, such as a wireless control box B for the roller shutter 9.

The home automation installation Su can comprise one or several sensors 5, integrated in an actuator 7, at a control point 15 or even at the control box B, or independently of these elements. A sensor 5 can, in particular, be arranged to measure a physical magnitude, for example a temperature sensor, a sunshine sensor or a humidity sensor. Position sensors 5 of home automation equipment 3 of the building 1, such as, for example, sensors for the opening state of a roller shutter 9 or position sensors of a door leaf such as a window, motorized or not, can also be provided. The home automation installation can also comprise one or several presence sensors. The installation can also comprise one or several electricity consumption sensors.

A home automation equipment 3 and a sensor 5 are thus to be considered as units having information available on the observed actual states of elements of the building 1 and being able to share this information with other elements of the home automation installation Su.

The home automation equipment 3 and the sensors 5 can thus have access to any measurable physical magnitude, such as the temperature of each room Ro1, Ro2, Ro3 or a state of an element of the building 1, such as the opening state of a roller shutter 9, the status of an alarm, etc.

Subsequently, we will use the designation of home automation device or device D interchangeably to designate sensors or home automation equipment, or parts of home automation equipment 3 or sensors 5.

The home automation devices generally comprise a processing unit comprising a processor executing an on-board software. This software is subject to updates to improve its functions or make corrections.

The home automation installation Su comprises a central control unit or a plurality of central control units U1, U2. Particularly and by way of example, two central control units U1, U2 are represented in FIG. 1. According to a variant, a home automation installation can also comprise a single central control unit.

Each central control unit U1, U2 is arranged to control and/or monitor a portion of the devices D of the installation Su forming a group DGrU1, DGrU2. By way of example, in FIG. 1, the central control unit U1 is in charge of devices D disposed in rooms Ro1 and Ro2 of the first floor of the building, while the central control unit U2 is in charge of devices D disposed in the room Ro3 on the ground floor of the building and external devices.

Particularly, the control and/or the monitoring is remotely carried out, in particular by using a wireless communication protocol, for example a radiofrequency communication protocol. Each central control unit U1, U2 is arranged to group together all the data coming from the devices D of its group DGrU1, DGrU2 and to process this data.

As represented in FIG. 2, a central control unit U1, U2 comprises a processing unit 2 arranged to contain and execute a first computer program. For example, the processing unit 2 comprises a processor, a storage flash memory as well as a random access memory, and an Ethernet chip.

The processing unit is arranged to execute an on-board software. This software is subject to updates to improve its functions or make corrections.

The central control unit U1, U2 further comprises at least one communication module 2′ intended to the controlling and/or the monitoring of the home automation equipment 3 and/or the sensors 5, the home automation equipment 3 possibly being actuators 7, lighting 21, an alarm system, or a video camera.

By way of example, as represented in FIG. 2, the communication module 2′ allows the monitoring and/or the controlling of at least one actuator 7, of a movable element of the building 1, such as for example a roller shutter 9, or an orientable sun shade 9′ or other actuators 7 or lightings 21, as previously described with reference to FIG. 1, according to at least one local communication protocol P0.

By way of example, the communication module 2′ can be designed to implement for example one or several local protocols P0, for example of the Z-Wave, EnOcean, IO Homecontrol, Somfy RTS, KNX, MODBUS, Wavenis, Philips HUE type. These local protocols are generally non-IP local communication protocols.

According to another possibility, for example in the context of alarm systems, the central control unit can be integrated into the home automation device. According yet to another possibility, it is also possible for the central control unit to be integrated into a router and/or a modem making a connection to a wide area network, in particular to the Internet.

When the central control unit is integrated into a home automation device, the communication module 2′ intended for the monitoring and/or the controlling of the device may be a communication module inner to the home automation device and/or a communication module intended for the monitoring and/or the controlling of other home automation devices.

The reception of information from a sensor 5 providing user presence information or values of environment parameters, such as temperature, humidity and brightness, is also provided. Likewise, the central unit U1, U2 can allow the monitoring and/or the controlling of an alarm system.

Each central control unit U1, U2 can further comprise a communication module 4′ arranged to communicate according to at least a first and/or a second communication protocol P1, P2 other than the local protocol P0 previously described. The first and second communication protocols P1, P2 can for example be communication protocols above the IP protocol on a local network, or even a generic point-to-point protocol. For example, the WEAVE application protocol using 6lowpan and thread transport protocols for a mesh network can constitute a first and/or second protocol P1, P2. Other examples include Bluetooth, BLE for Bluetooth Low Energy, or Wifi.

FIG. 2 represents a particular architecture of a home automation installation, in which the central control unit can only communicate locally, via the communication module 4′, with a communication terminal T1. This situation may correspond, for example, to the case of a home automation installation installed in a building in which internet access is not yet available. As a result, the communication module 4 is not functional.

The movable communication terminal T1 can be, for example, a smart phone, a laptop or a tablet. Alternatively, the final user could also make use of a stationary terminal, such as a desktop computer. The communication terminal T1 can contain and execute a container application software APPC.

Each central control unit U1, U2 further comprises a communication module 4 arranged to communicate with at least one remote server via a wide area network, of the Internet type for example. This communication module 4, associated with the at least one remote server, allows the remote control and/or monitoring of a central control unit U1, U2 and/or a home automation device attached to the central control unit.

The movable communication terminal T1 comprises a data input device and a display device, for example in the form of a touch control part of a screen of the terminal T1 and in the form of one or several buttons of the terminal T1. T1 can communicate directly with the central control unit U1, U2, via a local network LN, such as for example the local networks PN or PN′ previously described, and a local server SvI disposed on the central control unit U1, U2; T1 can also communicate with the central control unit U1, U2 through a router R outer to the central control unit U1, U2, as illustrated in FIG. 2.

The central control unit is equipped with a functional software which comprises a HMI interface and/or configuration parameters of a HMI interface. This functional software is stored in a memory of the central control unit U1, U2, or in a storage unit ST external to the central control unit U1 to which the communication terminal T1 can access via the local network LN, as illustrated in FIG. 2.

Method for Configuring a Terminal for the Monitoring of a Central Control Unit

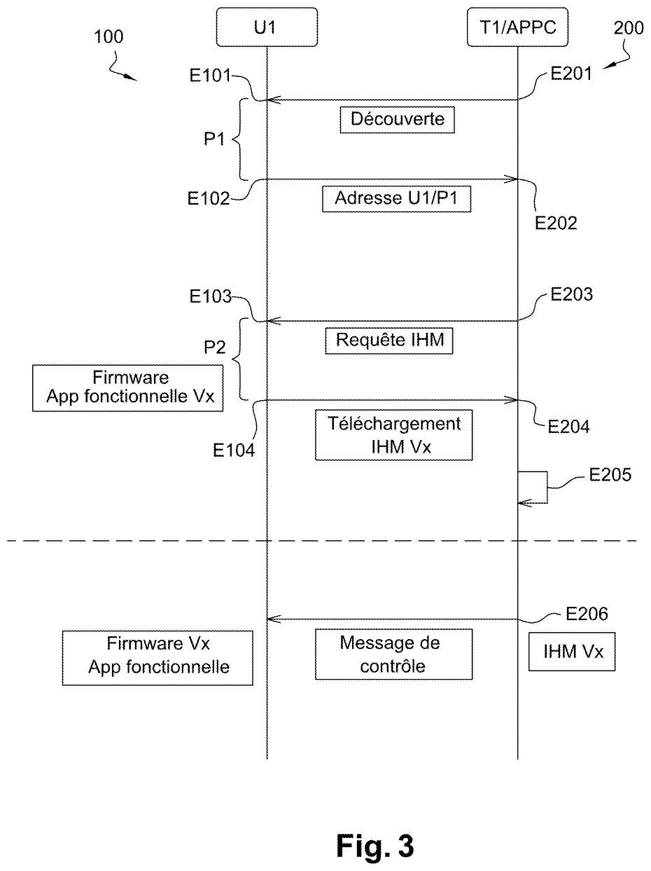

With reference to FIG. 3, the description of the configuration method will now relate more particularly to an embodiment of the invention in which the central unit U1 does not have any access to the wide area network, as represented in FIG. 2. The version Vx of the functional software of the central control unit U1 is unknown to the communication terminal T1, which communicates locally with the central control unit U1. The communication terminal T1 must therefore be configured according to the method of the invention in order to then be able to locally monitor the central control unit U1.

As indicated previously, the operating system or the functional software of the central control unit U1 is upgradeable, and the version Vx of the functional software, installed in the central control unit U1, is a priori unknown to the terminal communication T1.

The initial configuration of the terminal T1 comprises at least one container application APPC, designed to provide at least the following functions:
the implementation of a discovery step E201, E101 with the transmitting by the communication terminal of a discovery message E201, according to a first communication protocol P1, in broadcast mode for example, to the central control unit(s) U1, U2 which are within radiofrequency range of the terminal T1 in direct communication. The reception of the discovery message E101 by the dedicated communication module 4′ of a central control unit U1 for which the discovery message is intended, triggers an identification step E102, E202 of the central control unit, with transmitting E102 to the communication terminal T1, by the central control unit U1, of a message containing the download address of an HMI interface application according to the latest version Vx of the functional software of the central control unit U1, and possibly the identifier of a second communication protocol P2, applicable to request the download, from the central control unit U1 or from an outer storage unit ST, from this HMI interface and/or from the configuration parameters of an existing interface on the communication terminal T1. The HMI interface, once installed or configured in accordance with said parameters, allows ensuring a monitoring of the central control unit U1 from the communication terminal T1 via this HMI interface, in its Version Vx. According to one aspect of the invention, the first communication protocol P1 and the second communication protocol P2 may be different or identical; the first communication protocol P1 must at least make it possible to communicate in «broadcast» mode, i.e. with electronic units which are within the range of the transmitter, without the address of a particular recipient being specified. Thus, the first communication protocol P1 can for example be of the UPNP («Universal Plug and play Network Protocol») type. The second communication protocol P2 can for example be a HTTP type protocol.
the reception E202 by the communication terminal T1, of the identification message of the HMI interface of the predetermined version Vx of the functional software of the central control unit U1,
the transmitting E203 by the communication terminal T1 of a request intended for the central control unit U1 or the outer storage unit ST in order to request the download on the terminal T1, of the interface application HMI according to the predetermined version Vx. The reception E103 of the request, by the central control unit U1 or by the outer storage unit ST, triggers the download on the communication terminal T1 of this HMI interface, in its current version Vx, or of the configuration parameters of an interface already present on the communication terminal T1, for the monitoring and the communication with the central control unit U1,
The reception E204 of the HMI interface application according to the current version Vx, or of the configuration parameters of an existing interface on the communication terminal T1. The HMI interface, once installed or configured in accordance with said parameters, allows ensuring a monitoring of the central control unit U1 or of a home automation device belonging to the home automation installation from the communication terminal T1 via this HMI interface, in its Version Vx compatible with the version of the functional software of the central control unit U1.
the adaptation E205 of the configuration of the communication terminal T1, comprising the installation of the HMI interface application on the communication terminal T1 and/or the configuration of the existing interface on the communication terminal T1, so that the interface application, after adaptation, is configured to be compatible with the version Vx of a functional software of the central control unit U1.

Thus, thanks to the arrangements of the configuration method, the configuration of the terminal T1 not only comprises the container application APPC constituting the basic configuration for the discovery by the terminal T1 of a central control unit U1 within direct communication range, but also a HMI interface application configured according to the predetermined version Vx of the functional software of the central control unit U1. This allows the communication terminal T1 to monitor E206 and interact with the central control unit U1, regardless of the Version Vx of the functional software installed in the central control unit U1. Thus, the HMI interface application, after the implementation of said configuration method, is compatible with the predetermined version Vx of the central control unit U1.

Thanks to these arrangements, the communication terminal T1 can also take the monitoring of the home automation device(s) D which are attached to the central control unit U1 within the home automation installation Su.

The download of the interface application, or the configuration parameters of an existing interface application on the terminal may not be necessary each time the container application is started. The interface application or the configuration parameters downloaded the first time by the container application APPC to the terminal T1 may be persistent there, and do not need to be downloaded again if they do not have changed on the central control unit U1 or the outer storage unit ST, since the last download.

According to an alternative implementation mode, the interface application or the configuration parameters downloaded by the container application APPC on the communication terminal T1 can be installed non-persistently on the communication terminal T1. So, for example, after each exit of the application, each reset or each shutdown of the communication terminal, the interface application will have to be downloaded. Advantageously, this implementation mode allows a saving of memory space on the communication terminal T1.

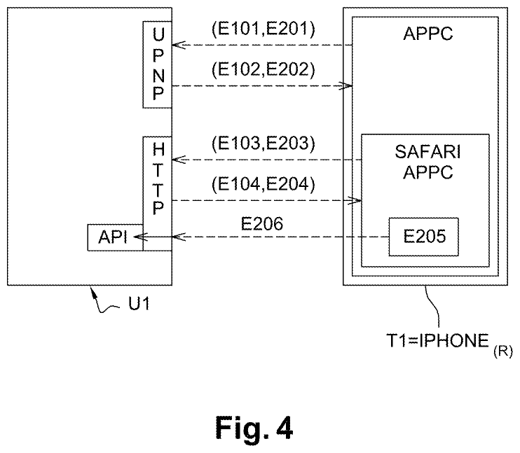

FIG. 4 is a representation of an exemplary implementation of the method according to the invention when the terminal T1 is a smart phone or a smartphone of the type marketed under the brand IPHONE. The implementation of the method can start only if the container application APPC is present on the terminal T1; for this, we can assume that the terminal T1 was able to have an internet connection via an internet service provider and was thus able to download the container application via the internet from a download platform, particularly from the APPSTORE® platform, prior to the implementation of the communication method.

Then the implementation of the method according to the invention can start with:

1. the steps E201, E101, E102, E202 of exchanging message according to the first protocol between UPNP between the container application APPC for the discovery of the central control unit U1, then the transmitting by the central control unit U1 and the reception by the terminal of a download address of the interface application HMI, or of the configuration parameters of an existing interface application;

2. the steps E203, E103, E104, E204 of exchanging messages according to the second protocol HTTP between an application of the SAFARI type in SAFARI/APPC container mode and the central control unit U1 which are concluded with the reception by the terminal T1 of the interface application HMI or of the configuration parameters;

3. the step E205 of installation, or of configuration according to the configuration parameters, of the interface application HMI on the terminal T1;

4. the control step E206 of the central control unit U1 by the terminal T1, via the installed or configured interface application HMI.

It should be noted that the configuration method can be implemented even if the communication terminal T1 does not have access to the Internet.

1. A method for configuring a communication terminal for monitoring a central control unit or a home automation device belonging to a home automation installation, the method being implemented by the communication terminal, an initial configuration of the communication terminal comprising at least one container application, the method, implemented by the communication terminal, comprising the following steps:
receiving an interface application and/or setting data of the interface application, downloaded from the central control unit or from an external storage unit;
adapting the configuration of the communication terminal, the adaptation step comprising an installation of the interface application downloaded on the communication terminal and/or a configuration of an interface application, present on the communication terminal before the receiving step, in order to make the interface application compatible with a predetermined version of functional software of the central control unit.

2. The configuration method according to claim 1, comprising the following step:
transmitting a request to download the interface application.

3. The configuration method according to claim 1, comprising the following steps:
transmitting a discovery message;
receiving an identification message containing a download address of the interface application.

4. The configuration method according to claim 3, wherein:
the step of transmitting the discovery message, and
the step of receiving the identification message,
are carried out according to a first communication protocol, and in which the step of receiving the interface application is carried out according to a second communication protocol.

5. The configuration method according to claim 2, wherein the step of transmitting the download request is performed according to a second communication protocol.

6. A Method for monitoring a central control unit or a home automation device belonging to a home automation installation implemented by a communication terminal, an initial configuration of the communication terminal comprising at least one container application, the central control unit comprising a predetermined version of a functional software and at least one communication module arranged to communicate with the container application, the method comprising the following steps:
implementing the configuration method according to claim 1;
sending a control message to the central control unit via the installed and/or configured interface application, during an adaptation step of the configuration method.

7. A method for configuring a communication terminal for monitoring a central control unit or a home automation device belonging to a home automation installation, an initial configuration of the communication terminal comprising at least one container application, the method being implemented by the central control unit, the central control unit comprising at least a communication module arranged to communicate with the container application, as well as a functional software and an interface application for the functional software, the method, implemented by the central control unit, comprising the following step:
downloading, via the communication module, the interface application and/or the setting data of the interface application on the communication terminal.

8. The configuration method according to claim 7, comprising a step of:
receiving, via the communication module, a download request, transmitted by the communication terminal.

9. The configuration method according to claim 7, comprising the following steps:
receiving a discovery message from the communication terminal;
transmitting an identification message containing a download address of the interface application, intended for the communication terminal.

10. The configuration method according to claim 9, wherein:
the step of receiving the discovery message, and
the step of transmitting the identification message,
are carried out according to a first communication protocol, and in which the step of downloading the interface application is carried out according to a second communication protocol.

11. The configuration method according to claim 8, wherein the step of receiving the download request is carried out according to a second communication protocol.

12. The configuration method according to claim 2, comprising the following steps:
transmitting a discovery message;
receiving an identification message containing a download address of the interface application.

13. The configuration method according to claim 12, wherein:
the step of transmitting the discovery message, and
the step of receiving the identification message,
are carried out according to a first communication protocol, and in which the step of receiving the interface application is carried out according to a second communication protocol.

14. A method for monitoring a central control unit or a home automation device belonging to a home automation installation implemented by a communication terminal, an initial configuration of the communication terminal comprising at least one container application, the central control unit comprising a predetermined version of a functional software and at least one communication module arranged to communicate with the container application, the method comprising the following steps:
implementing the configuration method according to claim 2;
sending a control message to the central control unit via the installed and/or configured interface application, during an adaptation step of the configuration method.

15. A method for monitoring a central control unit or a home automation device belonging to a home automation installation implemented by a communication terminal, an initial configuration of the communication terminal comprising at least one container application, the central control unit comprising a predetermined version of a functional software and at least one communication module arranged to communicate with the container application, the method comprising the following steps:
implementing the configuration method according to claim 3;
sending a control message to the central control unit via the installed and/or configured interface application, during an adaptation step of the configuration method.

16. A method for monitoring a central control unit or a home automation device belonging to a home automation installation implemented by a communication terminal, an initial configuration of the communication terminal comprising at least one container application, the central control unit comprising a predetermined version of a functional software and at least one communication module arranged to communicate with the container application, the method comprising the following steps:
implementing the configuration method according to claim 4;
sending a control message to the central control unit via the installed and/or configured interface application, during an adaptation step of the configuration method.

17. A method for monitoring a central control unit or a home automation device belonging to a home automation installation implemented by a communication terminal, an initial configuration of the communication terminal comprising at least one container application, the central control unit comprising a predetermined version of a functional software and at least one communication module arranged to communicate with the container application, the method comprising the following steps:
implementing the configuration method according to claim 5;
sending a control message to the central control unit via the installed and/or configured interface application, during an adaptation step of the configuration method.

18. The configuration method according to claim 8, comprising the following steps:
receiving a discovery message from the communication terminal;
transmitting an identification message containing a download address of the interface application, intended for the communication terminal.

19. The configuration method according to claim 18, wherein:
the step of receiving the discovery message, and
the step of transmitting the identification message,
are carried out according to a first communication protocol, and in which the step of downloading the interface application is carried out according to a second communication protocol.
